(19) United States
(12) Patent Application Publication
(10) Pub. No.: US 2014/0295200 A1
(43) Pub. Date: Oct. 2, 2014

(54) SELECTIVE COATING OF EXPOSED COPPER ON SILVER-PLATED COPPER

(71) Applicant: HENKEL IP & HOLDING GMBH, Duesseldorf (DE)

(72) Inventors: Jose Garcia-Miralles, Hoboken, NJ (US); Jie Cao, Hillsborough, NJ (US); Allison Vue Xiao, Belle Mead, NJ (US); Ciaran McArdle, Dublin (IE); David Farrell, Dublin (IE)

(21) Appl. No.: 14/305,053

(22) Filed: Jun. 16, 2014

Related U.S. Application Data
(63) Continuation of application No. PCT/US2012/028258, filed on Mar. 8, 2012.
(60) Provisional application No. 61/576,071, filed on Dec. 15, 2011.

(51) Int. Cl. C09J 11/04; B05D 7/14

(52) U.S. Cl. CPC C09J 11/04; B05D 7/14
USPC 428/570; 427/58

(57) ABSTRACT

Silver-plated copper particles in which any exposed copper not plated with silver are coated with a polymer or with a chelating compound capable of preventing oxidation of the exposed copper. A method for preventing oxidation of any exposed copper on silver-plated copper particles and for improving the conductivity of silver-plated copper particles comprises coating a polymer or a copper-chelating compound onto the exposed copper on the silver-plated copper particles.

### BACKGROUND OF THE INVENTION

This invention is related to a method for selectively coating exposed copper surfaces on silver-plated copper particles, and to the silver-plated copper particles on which any exposed copper is coated, with an anti-oxidation coating.

Conductive adhesive compositions comprising an adhesive resin and a conductive filler are used in the fabrication and assembly of semiconductor packages and microelectronic devices, both to mechanically attach, and to create electrical conductivity between, integrated circuit devices and their substrates.

Silver has the lowest electrical resistivity among single metals, and silver oxide is also conductive, unlike the oxides of other metals. Consequently, silver is widely used with resins and polymers to prepare conductive inks and adhesives for applications within the electronics industry. Silver, however, keeps increasing in price, driving the industry to find less expensive conductive fillers.

Copper has a bulk electrical resistivity similar to silver, and is less expensive than silver; however, it oxidizes readily and its oxides are not conductive, as those of silver are. An alternative now being tried within the semiconductor industry is silver-plated copper. This is not entirely satisfactory because commercially available silver-plated copper particles, in which the silver coating completely covers the copper particle core, are difficult, if not impossible, to obtain. The exposed copper on commercially available silver-plated copper particles is oxidized over time, and oxidation of the exposed copper causes a loss in conductivity. This creates a need for improving the conductivity of silver-plated copper particles.

### SUMMARY OF THE INVENTION

This invention is silver-plated copper particles in which any copper not plated with silver (hereinafter “exposed copper”) is coated with a polymer or with a chelating compound capable of preventing oxidation of the exposed copper.

The polymer is formed in-situ by a polymerization reaction that is catalyzed by copper or copper ions present on the exposed copper surface of the silver-plated copper particles. The polymerization has selectivity to copper relative to silver; that is, the copper or copper ions catalyze the polymerization faster and with less energy than silver or silver ions will do. The chelating compound is one that has selectivity to copper relative to silver, meaning that the chelating compound will interact preferably with the copper surface, using less energy than it will with the silver surface.

In another embodiment, this invention is a method for preventing oxidation of any exposed copper on silver-plated copper particles comprising forming a polymer on, or coating a copper-chelating compound onto, the exposed copper on the silver-plated copper particles. In a further embodiment, this invention is a method for improving the conductivity stability of silver-plated copper particles comprising forming a polymer on, or coating a copper-chelating compound onto, the exposed copper on the silver-plated copper particles.

The methods for preventing oxidation of any exposed copper on silver-plated copper particles, or for improving the conductivity stability of silver-plated copper particles, in which a polymer is formed on the exposed copper on the silver-plated copper particles, comprise coating monomers that will polymerize in the presence of copper or copper ions onto the silver-plated copper particles, and allowing the monomers to polymerize. When needed, the method may also include the step of washing the silver-plated copper particles to remove any polymerization product from the silver surface of the silver-plated copper particles.

The methods for preventing oxidation of any exposed copper on silver-plated copper particles, or for improving the conductivity stability of silver-plated copper particles, in which a chelating compound is coated onto the exposed copper on the silver-plated copper particles, comprise coating a chelating compound having a stronger binding force to copper than to silver onto the silver-plated copper particles. When needed, the method may also include the step of washing the silver-plated copper particles to remove any chelating compound from the silver surface of the silver-plated copper particles.

### DETAILED DESCRIPTION OF THE INVENTION

Silver-plated copper particles can be obtained commercially, for example, from Ferro Corporation or Ames Goldsmith Corporation.

One embodiment of the invention, in which a polymer is formed on the exposed copper of silver-plated copper particles, comprises forming the polymer in-situ by a polymerization reaction catalyzed by copper or copper ion present on the exposed copper surface of the silver-plated copper particles. In these reactions, since copper or copper ions are not a part of the coating formulation and are only available on the copper surface, the coating is preferentially formed on the copper surface. In general, these reactions occur at room temperature; in other embodiments, some polymerizations may need heat or irradiation to proceed.

An exemplary polymerization reaction is that in which aniline is polymerized by catalytic oxidation to polyaniline using hydrogen peroxide in the presence of the exposed copper and/or copper ions on the silver-plated copper particles. (Copper ions are typically always present on the elemental copper because copper is relatively easily oxidized.) The in-situ generated polyaniline bonds to the superficial copper by chemisorption, thus protecting the copper from oxidation. Any polyaniline that may have been absorbed onto the surface of the silver can be removed by an appropriate solvent wash.

Suitable oxidizing agents include, but are not limited to, hydroperoxides, diacyl peroxides, dialkyl peroxides, peroxydicarbonates, peroxymono-carbonates, cyclic peroxides, peroxyesters, peroxyketals and azo initiators. Specific examples of peroxide oxidizing agents include benzoyl peroxide, lauroyl peroxide, octanoyl peroxide, butyl peroctoate, dicumyl peroxide, acetyl peroxide, p-chlorobenzoyl peroxide and di-t-butyl diperphthalate, t-butyl perbenzoate; specific examples of azo initiators include azobisisobutyronitrile, 2,2′-azobispropane, 2,2′-azobis(2-methylbutanenitrile), and m,m′-azoxystyrene.

Solvent is used in this process to dissolve the reactants, which helps to improve coating selectivity and coating quality on the particles. Suitable solvents include, but are not limited to, acetone, alcohol, toluene, THF, water, and ethyl acetate; a preferred solvent is isopropyl alcohol.

Another exemplary polymerization reaction is that in which radical polymerization occurs through an oxidation/reduction reaction (redox) initiated by an oxidizing agent (such as peroxide) reacting with elemental copper and/or copper(I) ions (reductants) available on the exposed copper surface. These redox reactions can happen in aqueous or organic media depending on the solubility of the initiator and the metal ions.

Any organic or inorganic radical initiator can be used in this process, and suitable initiators are selected from hydroperoxides, diacyl peroxides, dialkyl peroxides, peroxy-dicarbonates, peroxymonocarbonates, cyclic peroxides, peroxyesters, peroxyketals, and azo initiators. Specific examples of peroxide oxidizing agents include benzoyl peroxide, lauroyl peroxide, octanoyl peroxide, butyl peroctoate, dicumyl peroxide, acetyl peroxide, p-chloro-benzoyl peroxide and di-t-butyl diperphthalate, t-butyl perbenzoate; specific examples of azo initiators include azobisisobutyronitrile, 2,2′-azobispropane, 2,2′-azobis(2-methylbutane-nitrile), and m, m ‘-azoxystyrene.

Reactive monomers that can be polymerized using an oxidation/reduction reaction are any that have carbon to carbon unsaturation. Suitable monomers include, but are not limited to, acrylates, methacrylates, and maleimides.

The acrylate and methacrylate resins are selected from aliphatic, cycloaliphatic, and aromatic acrylates and methacrylate.

Specific reactive monomers include, but are not limited to, triethylene glycol dimethacrylate (TGM), (SR205), alkoxylated hexanediol di(meth)acrylate (SR560), trimethylolpropane tri(meth)acrylate (SR350, SR35111), tricyclodecane dimethanol diacrylate, (SR833s), dicyclopentadienyl methacrylate (CD535), ethoxylated bisphenol A di(meth)acrylate (SR348, SR349, CD540, SR541, CD542), tris (2-hydroxy ethyl) isocyanurate triacrylate (SR368 or SR368D), polybutadiene urethane dimethacrylate (CN302, NTX6513) and polybutadiene dimethacrylate (CN301, NTX6039, PRO6270), and epoxy acrylate resins (CN104, 111, 112, 115, 116, 117, 118, 119, 120, 124, 136), all commercially available from Sartomer Company, Inc.

Other suitable reactive monomers include, but are not limited to, 2-[3-(2H-benzotriazol-2-yl)-4-hydroxyphenyllethyl methacrylate, 2-(diethylamino)ethyl acrylate, 2-N-morpholinoethyl methacrylate, 2-(dimethylamino)ethyl methacrylate, 2-(diethylamino)ethyl methacrylate, ethyl 3-(2-amino-3-pyridyl)-acrylate, (E)-methyl 3-(2-amino-5-methylpyridin-3-yl)acrylate, methyl 3-(2-amino-4-methoxypyridin-3-yl)acrylate, all commercially available from Aldrich.

Further suitable reactive monomers include, but are not limited to, hydroxypropyl methacrylate (HPMA), hydroxyethylmethacrylate (HEMA), tetrahydrofurfuryl acrylate, zinc acrylate, butyl(meth)acrylate, isobutyl(meth)acrylate, 2-ethyl hexyl(meth)acrylate, isodecyl(meth)acrylate, n-lauryl(meth)acrylate, alkyl(meth)acrylate, tridecyl(meth)acrylate, n-stearyl(meth)acrylate, cyclohexyl(meth)acrylate, tetrahydrofurfuryl-(meth)acrylate, 2-phenoxy ethyl(meth)acrylate, isobornyl(meth)acrylate, 1,4-butanediol di(meth)acrylate, 1,6-hexanediol di(meth)acrylate, 1,9-nonandiol di(meth)acrylate, perfluorooctylethyl(meth)acrylate, 1,10 decandiol di(meth)-acrylate, nonylphenol polypropoxylate(meth)acrylate, and polypentoxylate tetrahydrofurfuryl acrylate, all commercially available from Kyoeisha Chemical Co., LTD.

Additional suitable reactive monomers include polycarbonate urethane diacrylate (ArtResin UN9200A) available from Negami Chemical Industries Co., LTD; acrylated aliphatic urethane oligomers (Ebecryl 230, 264, 265, 270,284, 4830, 4833, 4834, 4835, 4866, 4881, 4883, 8402, 8800-20R, 8803, 8804) available from Radcure Specialities, Inc; and polyester acrylate oligomers (Ebecryl 657, 770, 810, 830, 1657, 1810, 1830) available from Radcure Specialities, Inc.

In one embodiment, the reactive monomers are selected from the group consisting of triethylene glycol dimethacrylate, alkoxylated hexanediol di(meth)acrylate, trimethylolpropane tri(meth)acrylate, tricyclodecane dimethanol diacrylate, dicyclopentadienyl methacrylate, ethoxylated bisphenol A di(meth)acrylate, tris (2-hydroxy ethyl) isocyanurate triacrylate, hydroxypropyl methacrylate (HPMA), hydroxyethylmeth-acrylate (HEMA), tetrahydrofurfuryl acrylate, and zinc acrylate. Combinations of these are also suitable, as are combinations of these with other mentioned acrylate resins.

In a further embodiment, the reactive monomers are selected from the group consisting of 2-[3-(2H-benzotriazol-2-yl)-4-hydroxyphenyl] ethyl methacrylate, 2-(diethylamino)-ethyl acrylate, 2-N-mornholinoethyl methacrylate, 2-(dimethylamino)ethyl methacrylate, 2-(diethyl-amino)ethyl methacrylate, ethyl 3-(2-amino-3-pyridyl)acrylate, (E)-methyl 3-(2-amino-5-methylpyridin-3-yl)acrylate, methyl 3-(2-amino-4-methoxypyridin-3-yl)acrylate, isobornyl acrylate, isobornyl methacrylate, lauryl acrylate, lauryl methacrylate, poly(butadiene) with acrylate functionality and poly(butadiene) with methacrylate functionality. Combinations of these are also suitable, as are combinations of these with other mentioned acrylate resins.

Exemplary maleimide resins include, but are not limited to, N-butylphenyl maleimide and N-ethylphenyl maleimide. Other suitable maleimide resins are those having the structures

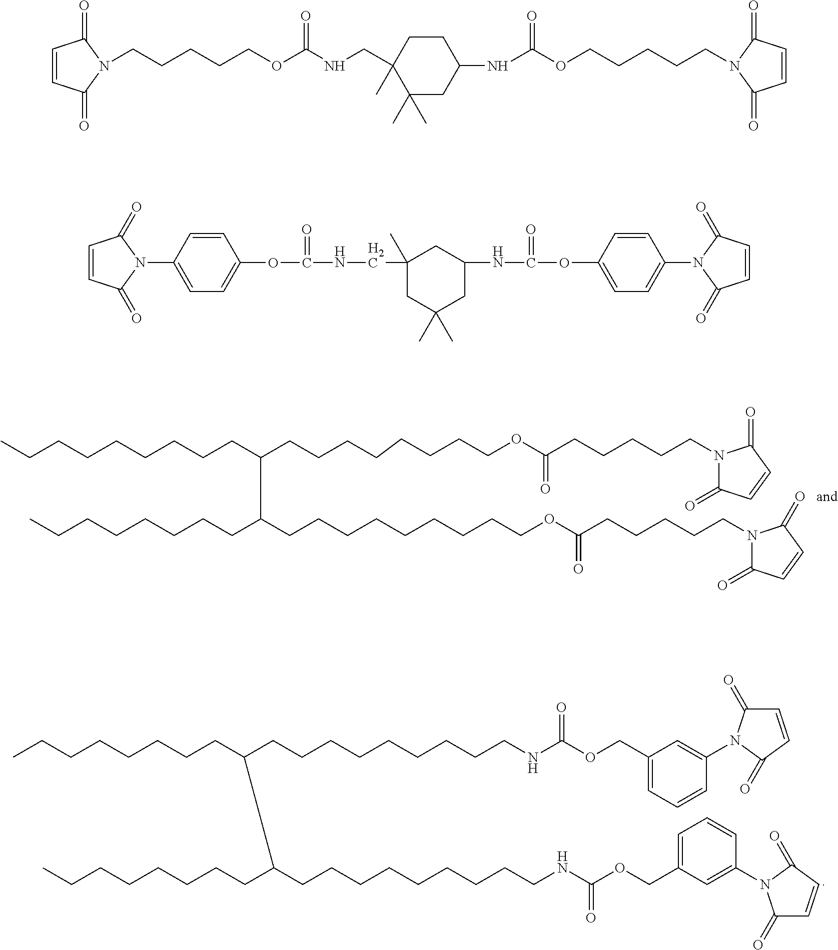 [SMILES: CC1(C)CC(NC(=O)OCCCCCN2C(=O)C=CC2=O)CCC1(C)CNC(=O)OCCCCCN1C(=O)C=CC1=O ; CC1(C)CC(NC(=O)Oc2ccc(N3C(=O)C=CC3=O)cc2)CC(C)(CNC(=O)Oc2ccc(N3C(=O)C=CC3=O)cc2)C1 ; CCCCCCCCCC(CCCCCCCCOC(=O)CCCCCN1C(=O)C=CC1=O)C(CCCCCCCC)CCCCCCCCCOC(=O)CCCCCN1C(=O)C=CC1=O ; "and" ; CCCCCCCCC(CCCCCCCCCNC(=O)OCc1cccc(N2C(=O)C=CC2=O)c1)C(CCCCCCCC)CCCCCCCCCNC(=O)OCc1cccc(N2C(=O)C=CC2=O)c1]

In some cases a solvent is used to dissolve the monomer, initiator, and metal ion, which helps to improve coating selectivity and coating quality. Suitable solvents include, but are not limited to, acetone, alcohol, toluene, tetrahydrofuran (THF), and ethyl acetate.

In a further embodiment, polymerization takes place by the cationic ring opening of an epoxy, or an oxetane, catalyzed by copper or copper ions. A combination of silver salt and the exposed elemental copper is used to generate the cationic species by an oxidation/reduction reaction that initiates polymerization. An epoxy or oxetane resin and a silver salt are introduced to the surface of the particles. The exposed elemental copper reduces the silver ion to elemental silver and itself is oxidized to copper ion. The acid form of the copper salt anion cationically initiates the polymerization of the epoxy, or oxetane. The epoxy and oxetane can be aliphatic, cycloaliphatic, or aromatic.

Suitable cycloaliphatic epoxy resins include 3,4-epoxycyclohexylmethyl-3,4-epoxycyclohexane carboxylate (Union Carbide, ERL-4221), (Ciba-Geigy, CY-179); bis(3,4 epoxycyclohexyl-methyl) adipate (Union Carbide, ERL-4299)(liquid); and 1,2-epoxy-4-(2-oxiranyl)-cyclohexane with 2,2-bis(hydroxymethyl)-1-butanol (Daicel Chemical Industries, EHPE 3180) (solid).

Suitable multifunctional aromatic epoxy resins include, but are not limited to, monofunctional and multifunctional glycidyl ethers of Bisphenol-A and Bisphenol-F (CVC Specialty Chemicals, Resolution Performance Products LLC, Nippon chemical Company, and Dainippon Ink & Chemical); 2,6-(2,3-epoxypropyl) phenylglycidyl ether (proprietary to Henkel Corp.); polyglycidyl ethers of phenol-formaldehyde novolac resins (CVC Chemicals); tetraglycidyl 4,4′-diamino diphenyl methane (Ciba Specialty Polymers); epoxy novolac resin, (such as, poly(phenyl glycidyl ether)-co-formaldehyde); biphenyl epoxy resin (prepared by the reaction of biphenyl resin and epichlorohydrin); dicyclopentadiene-phenol epoxy resin; epoxy naphthalene resins; and epoxy functional butadiene acrylonitrile copolymers.

Other suitable epoxies include 3,4-epoxycyclohexylmethyl-3,4-epoxycyclohexane carboxylate, which contains two epoxide groups that are part of the ring structures and an ester linkage; vinylcyclohexene dioxide, which contains two epoxide groups, one of which is part of the ring structure; 3,4-epoxy-6-methyl cyclohexyl methyl-3,4-epoxycyclohexane carboxylate; and dicyclopentadiene dioxide.

Suitable oxetane compounds include 3-methyl-3-hydroxymethyloxetane, 3-ethyl-3-hydroxy-methyloxetane, 3-methyl-3-bromomethyloxetane, 3-ethyl-3-bromomethyloxetane, 3-methyl-3-alkylbromo-methyloxetane, 3-ethyl-3-alkylbromomethyloxetane, 3-methyl-3-tosylmethyloxetane, and 3-ethyl-3-tosylmethyl-oxetane.

Other oxetane compounds include those prepared from 3-ethyl-3-(hydroxymethyl)oxetane and a co-reactive compound obtained as follows:

the reaction of 3-ethyl-3-(hydroxymethyl) oxetane with m-tetramethyl-xylene diisocyanate to give the compound

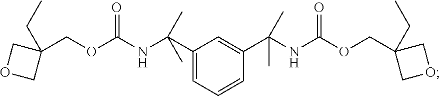 [SMILES: CCC1(COC(=O)NC(C)(C)c2cccc(C(C)(C)NC(=O)OCC3(CC)COC3)c2)COC1]

the reaction of 3-ethyl-3-(hydroxymethyl) oxetane with azelaoyl chloride to give the compound

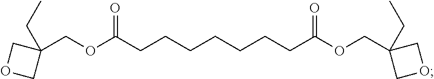 [SMILES: CCC1(COC(=O)CCCCCCCC(=O)OCC2(CC)COC2)COC1]

the reaction of 3-ethyl-3-(hydroxymethyl) oxetane with terephthaloyl chloride to give the compound

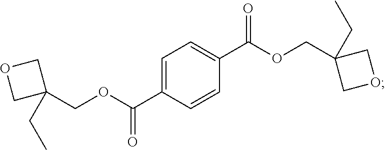 [SMILES: CCC1(COC(=O)c2ccc(C(=O)OCC3(CC)COC3)cc2)COC1]

and

the reaction of 3-ethyl-3-(hydroxymethyl) oxetane with 1,3,5-benzene-tricarbonyl trichloride to give the compound

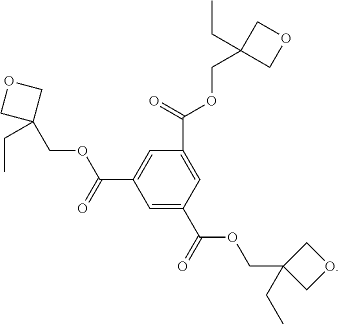 [SMILES: CCC1(COC(=O)c2cc(C(=O)OCC3(CC)COC3)cc(C(=O)OCC3(CC)COC3)c2)COC1]

In a further embodiment, polymerization can take place by the cationic polymerization of vinyl ether or a mixture of vinyl ether, epoxy, or oxetane. Suitable epoxy and oxetane resins are those described earlier. As with epoxy and oxetane, polymerization of vinyl ether takes place by cationic polymerization catalyzed by copper or copper ions. A combination of silver salt and the exposed elemental copper is used to generate the cationic species by an oxidation/reduction reaction that initiates polymerization. A vinyl ether resin and a silver salt are introduced to the surface of the particles. The exposed elemental copper reduces the silver ion to elemental silver and itself is oxidized to copper ion. The acid form of the copper salt anion cationically initiates the polymerization. The vinyl ether can be aliphatic, cycloaliphatic, or aromatic.

Suitable vinyl ether compounds include, but are not limited to, triethyleneglycol divinyl ether (RAPICURE-DVE-3), butanediol divinyl ether (RAPICURE-DVB1D), 1,4-cyclohexanedimethylol divinyl ether (RAPICURE-CHVE), tripropylene glycol divinyl ether (RAPICURE-DPE-3) or dodecyl vinyl ether (RAPICURE-DDVE), available from International Specialty Products. Analogous vinyl ethers are available from BASF. Vinyl ether-terminal urethanes and polyesters are available from Morflex.

A further exemplary polymerization reaction is that involving the so-called “click” chemistry. In this polymerization, the polymer coating is the 1,2,3-triazole reaction product of an azide and an alkyne in which the polymerization is catalyzed by copper(I) ions, or copper(II) ions in combination with a reducing agent. The copper ions are formed from the exposed copper surface. The reaction proceeds through mild and neutral conditions in high efficiency. The temperature used to initiate and maintain the polymerization will be usually within the range of 25° C. to 200° C. The reaction can be run in solvent or as a bulk polymerization. Suitable solvents include acetone, alcohol, toluene, THF, and ethyl acetate.

The reactants containing azide functionality can be monomeric, oligomeric, or polymeric, aliphatic or aromatic, and with or without heteroatoms (such as, oxygen, nitrogen and sulfur). Examples of the various azides that can be used include sulfonyl azides, alkyl azides with one, two or more azide functionalities, such as tosyl azide; methyl azide, ethyl azide, nonyl azide; N,N-bis-(2-azido-ethyl)-4-methyl-benzensulfonamide, polyoxyethylene bis(azide), 2,2,2-tris(azidomethyl)ethanol, and tris(azidomethyl)aminomethane).

Suitable polymeric azides include (meth)acrylate base polymers with pendant azide functionality having the structures:

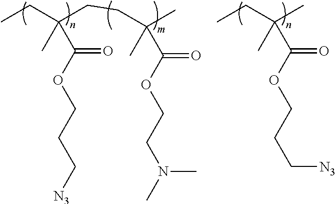

The synthetic procedures for these poly(meth)acrylate base polymers with pendant azide functionality are conducted according to B. S. Sumerlin, N. V. Tsarevsky, G. Louche, R. Y. Lee, and K. Matyj aszewski, Macromolecules 2005, 38, 7540-7545.

Other suitable polymeric azides include polystyrene base polymers with azide functionality having the structures in which n is an integer of 1 to 500:

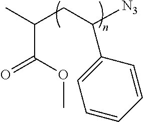

The synthetic procedures for polystyrene base polymers with azide functionality are conducted according to J-F.Lutz, H.G.Borner, K. Weichenhan, Macromolecular Rapid Communications, 2005, 26, 514-518.

Another suitable polymeric azide is dimer azide, prepared from dimer diol, having the structure:

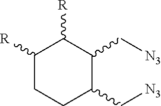

in which R is a long chain hydrocarbon radical from the dimer diol starting material. Preparation for this compound is disclosed in PCT publication WO2008/048733.

A further suitable polymeric azide is a polyether azide having the structure:

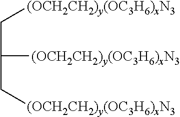

Preparation for this compound is disclosed in PCT publication WO2008/048733.

The reactants containing alkyne functionality can be aliphatic or aromatic. Exemplary alkynes include ethyl propiolate (propargylic acid ethyl ester), propargyl ether, bisphenol-A propargyl ether, 1,1,1-trishydroxy-phenylethane propargyl ether, dipropargylamine, tripropargylamine, N,N,N′,N′-tetrapropargyl-m-phenylene-dioxydianiline, and nonadiyne.

Another embodiment, in which a chelating compound is coated onto the exposed copper on a silver-plated copper particle, comprises coating a chelating compound having a stronger binding force to copper than to silver onto the silver-plated copper particles. When needed, the further step of washing the silver-plated copper particles to remove any chelating compound from the silver surface can be performed. In general, these chelations occur at room temperature; in other embodiments, the chelation may need the application of heat to proceed.

An exemplary chelating process comprises the use of a chelating compound to form a Cu(II) inhibitor complex that covers the exposed copper surface on silver plated copper particles. The chelating agent is chosen to have a weaker binding force to the surface of silver than to the surface of copper and can be removed from the silver surface by an appropriate solvent wash.

Exemplary chelating agents include nitrogen, phosphorus, and sulfur containing compounds, such as those selected from the group consisting of oximes, azoles, amines, amides, amino acids, thiols, phosphates and xanthates.

Examples of suitable oximes include salicylaldoxime, a-benzoin oxime, hydroxy benzophenoxime, L-hydroxy-5-nonylacetonphenone oxime; other oximes are amidoximes and long alkyl chain (such as, dodecyl, hexadecyl, octadecyl) oximes.

Examples of suitable azoles include 2-ethyl-4-methylimidazole, 1-H benzotriazole, 2,5-dimercapto-1,3,4-thiadiazole, 3-amino-1,2,4-triazole, 2-amino-1,3,4-thiadiazole, 2-amino-thiazole, and 2-aminobenzothiazole. Examples of suitable amines include N-N′-diphenyl-p-phenylenediamine and N-N′-bis(salicylidene)ethylenediamine,

An example of a suitable amide is sodium octyl hydroxamate. Examples of suitable amino acids include cysteine, tryptophan, and triphenylmethane derivatives. Other nitrogen containing compounds that are suitable are benzopyridazines and anilines.

Suitable thiols include 1,3,4-thiadiazole-2,5-dithiol and benzenethiol. A suitable phosphate is triphenyl phosphate. A suitable organo sulfur compound is potassium ethyl xanthate.

### EXAMPLES

All coating reactions took place at room temperature and were catalyzed by the exposed copper and copper ions on the silver-plated copper particles that were treated. All epoxy resin compositions were cured for 30 minutes at 170° C. under nitrogen. In the tables, E-02=1×10⁻², E-03=1×10⁻³ and E-04=1×10⁻⁴ and SR means Sheet Resistivity and is given in the values of ohm.cm.

### Example 1

### Polymerization of Aniline for Selective Coating to Exposed Copper on Ag/Cu Particles

This example describes the process to selectively coat exposed copper on the surface of silver-plated-copper particles (Ag/Cu) obtained from a commercial supplier.

The process consists of the oxidation of aniline to polyaniline by hydrogen peroxide using the exposed superficial Cu as the catalyst. The in-situ generated polyaniline bonds to the exposed Cu by chemisorption. Any polyaniline physically absorbed on the silver surface is removed by solvent wash. The reactants are set out in the following table:

| | Ag/Cu 1A | Ag-Cu 1B |
|---|---|---|
| Coating Composition | Grams | Grams |
| Reaction Solution | | |
| Isopropyl alcohol (IPA) | 126.6 | 126.6 |
| (Honeywell HPLC grade) | | |
| Silver-Plated Copper (Ag/Cu) | 20 | 20 |
| Aniline (Aldrich) | 0.63 | 0.32 |
| Aniline to Ag/Cu weight ratio | 3.15% | 1.6% |
| Oxidizing agent solution | | |
| De-ionized Water | 24 | 24 |
| Hydrogen Peroxide/30% vol (Aldrich) | 1.9 | 0.96 |

Into two separate 400 ml flasks were added the isopropyl alcohol (IPA) and the aniline for each of examples Ag/Cu 1A and Ag/Cu 1B. Each mixture was stirred at medium speed using an overhead stirrer. Silver-plated copper (Ag/Cu) was added to each and the mixtures stirred for 15 minutes to ensure good dispersion of the metal particles in the solvent. In separate 50 ml flasks, the oxidizing agent solutions were prepared by mixing together the deionized water and hydrogen peroxide. The oxidizing agent solutions were added slowly to the reaction solutions using an addition funnel. The reaction mixes were stirred vigorously for two hours at room temperature. Each silver-plated copper product was then washed three times with 50 g isopropyl alcohol using centrifugation, filtered, and vacuum dried at 70° C. for one hour. Each sample was left open to the air overnight to allow evaporation of any residual solvent.

The electrical performance (conductivity) of each filler was evaluated in an epoxy resin composition containing 80 weight percent (wt %) filler and 19 wt % epoxy resin plus 1% curing agent.

The epoxy resin was EPICLON 835 LV from DIC formally known as Dainippon Ink and Chemical. The hardener curing agent was OMICURE EM124 from CVC Specialty Chemicals. The control composition contained the same silver-plated copper as the samples, but the silver-plated copper was untreated. The compositions are set out in the following table.

Adhesive

| Composition | Control | Ex-1A | Ex-1B |
|---|---|---|---|
| epoxy resin | 19 wt % | 19 wt % | 19 wt % |
| curing agent | 1 wt % | 1 wt % | 1 wt % |
| Ag/Cu | 80% | | |
| Ag/Cu 1A | | 80% | |
| Ag/Cu 1B | | | 80% |

(The following method was used for all the examples in this specification.) Preparation of the electrical resistance test vehicle was accomplished by printing the conductive material as a tract (in the shape of a rectangle) on a glass substrate and curing it. The electrical resistivity of each conductive material sample was calculated as sheet resistivity from the equation: Sheet Resistivity (SR)=(R×t)/(N) (ohm.cm) in which R is the actual bulk resistance of the conductive material tract, N is the number of squares in the conductive tract obtained by multiplying length times width using the same unit of value for length and width, and t is the dried coating thickness.

The bulk resistance R was measured using a 4-terminal probe (Model Keithly Multimeter). The coating thickness, t, was measured using a digimatic indicator (Model 543-452B by Mitutoya).

After application to the glass slide, the epoxy resin compositions, filled with Ag/Cu, were cured for 30 minutes at 170° C. under nitrogen, after which the bulk resistance was measured. The samples were then set for aging in an 85° C./85% relative humidity chamber and change in SR was determined over time.

The results are reported in the following table and show that the samples Ex-1A and Ex-1B containing the polyaniline treated Ag/Cu filler show similar initial SR to the control, and improved aging stability compared to the control. This indicates that the selective coating of the polyaniline onto the exposed copper on the Ag/Cu surface was effective. SR is recorded in the values of ohm.cm.

| | | | | | | | Increase |
|---|---|---|---|---|---|---|---|
| | | SR at | SR at | SR at | SR at | SR at | in SR at |
| Sample | SR initial | 100 hrs | 150 hrs | 325 hrs | 500 hrs | 675 hrs | 675 hrs |
| Control | 4.83 E−04 | 6.04 E−04 | 7.64 E−04 | 7.81 E−04 | 1.08 E−03 | 3.24 E−03 | 571% |
| Ex-1A | 1.01 E−03 | 1.08 E−03 | 1.19 E−03 | 1.61 E−03 | 2.04 E−03 | 2.67 E−03 | 171% |
| Ex-1B | 7.65 E−04 | 7.59 E−04 | 7.22 E−04 | 8.07 E−04 | 8.08 E−04 | 9.69 E−04 | 27% |

### Example 2

### Polymerization of Aniline at Different Concentrations for Selective Coating to Exposed Copper on Ag/Cu Particles

Samples of Ag/Cu with different levels of polyaniline on the surface were prepared following the reaction procedure described in Example 1. All reactants and reaction conditions were kept constant, and only the level of aniline was varied in the samples.

After the coating reaction, the samples of the Ag/Cu fillers were held at 150° C. for 30 minutes and then injected into the GCMS (gas chromatography, mass spectrometry) to determine the polyaniline levels.

The electrical performance of the polyaniline coated Ag/Cu fillers was evaluated in an epoxy resin composition using the procedure described in Example 1. Results are set out in the following table and show that increases in concentration of aniline to coat the same amount of Ag/Cu do not affect the initial sheet resistivity, which indicates good selectivity in the coating of the exposed copper. SR is recorded in the values of ohm.cm.

| Aniline/AgCu | Aniline/IPA | polyaniline | SR initial^{a} | SR initial^{b} |
|---|---|---|---|---|
| weight ratio | weight ratio | (ppm) | (ohm.cm) | (ohm.cm) |
| 0% | 0% | <1 | 3.11E−03 | 2.52E−04 |
| 0.95% | 0.15% | 7.2 | 2.99E−03 | 2.37E−04 |
| 1.60% | 0.25% | 23.7 | 3.24E−03 | 6.74E−04 |
| 6.33% | 1% | 26.4 | 5.63E−03 | 6.58E−04 |
| 12.66% | 2% | 71 | 7.51E−03 | 1.55E−03 |

^{a}The conductive adhesive formulation contained 16 wt % epoxy resin (EPON 863), 4 wt % curing agent (AJICURE PN50) and 80 wt % Ag/Cu filler. Films were cured in a conventional air oven for one hour at 120° C.
^{b}The conductive adhesive formulation contained 19 wt % epoxy resin (EPICHLON 835LV), 1 wt % curing agent (OMICURE EMI24) and 80 wt % Ag/Cu filler. Films were cured under nitrogen for one hour at 175° C.

### Example 3

### Chelation of Salycilaldoxime to Exposed Copper for Selective Coating to Exposed Copper on Ag/Cu Particles

In this example, Ag/Cu particles were treated with salycilaldoxime, an organic copper corrosion inhibitor. The same Ag/Cu particles used in the samples were used untreated for the control sample.

In a 100 ml flask, salycilaldoxime (0.5 g for Ex. 3A and 0.25 g for example 3B) was dissolved in deionized water (50 g) using a magnetic stirrer and applying mild heat. The mixture was cooled to room temperature, and then 10 g of Ag/Cu particles were added and vigorous stirring applied for two hours, still at room temperature. The Ag/Cu particles were centrifuged three times with deionized water (50 g), filtered, and vacuum dried for one hour at 80° C.

The samples were studied under thermogravimetric analysis (TGA) and the results showed a shift on the oxidation curve of Ag/Cu from 220° C. for the control to approximately 280° C. for examples 3A and 3B. This indicates that oxidation of the exposed copper is hindered by salycilaldoxime.

The electrical performance of the Ag/Cu fillers was evaluated in an epoxy resin composition using the procedure described in Example 1. The composition contained 16 wt % epoxy resin (EPON 863), 4 wt % curing agent (AJICURE PN50) and 80 wt % Ag/Cu filler. Particles of untreated Ag/Cu were used as the control at the same level of loading as the coated particles.

The samples (on glass slides) were cured for 30 minutes at 170° C. under nitrogen. Electrical performance was measured right after the curing and after aging for 800 hours at 85° C./85% RH (relative humidity). The results are set out in the following table and show that the samples treated with the oxime did not suffer as great a loss in conductivity after aging as did the control sample. The untreated sample had a greater gain in sheet resistivity compared to the two treated samples. This indicates there was high selectivity for the oxime coating on the copper, and the majority of the silver surface was not affected by the oxime. SR is recorded in the values of ohm.cm.

| | | SR after 800 h @ | |
|---|---|---|---|
| | SR initial | 85 C./85% RH | SR increase |
| Control | 1.58E−03 | 2.40E−03 | 52% |
| Ex-3A | 1.95E−03 | 2.25E−03 | 15% |
| Ex-3B | 1.63E−03 | 2.22E−03 | 36% |

The TGA results in combination with the sheet resistivity results show that the oxidation stability of Ag/Cu filler treated with oximes is improved, while still maintaining conductivity performance.

### Example 4

### Comparative. Coating of a Conductive Polymer without Selectivity to Copper

I. Binding Selectivity of Poly(3,4-ethylenedioxythiophene): Polystyrenesulfonate Solution on Cu and Ag Surfaces.

PEDOT:PSS (2.5 wt % in water, from Aldrich) was coated onto a copper substrate and a silver substrate. The solvent was allowed to evaporate and the coating allowed to form by keeping the substrates at room temperature for 16 hours. The coated substrates were then washed with acetone and the residual films observed on both substrates by unaided visual observation and by IR. The observations showed that both surfaces retained the coating, indicating that the PEDOT:PSS did not selectively coat on copper.

II. Electrical Performance of Ag/Cu Particles Coated with PEDOT-PSS.

In a 250 mL flask were added an aqueous solution of PEDOT: PSS (2.5% solid, high conductivity grade from Aldrich) (1.0 g of solution in example 4A, and 0.20 g of solution in example 4B), silver-plated copper (15.0 g from a proprietary source) and acetone (30 mL). The mixture was stirred for two hours at room temperature, after which the Ag/Cu was allowed to settle and the supernatant decanted off. Then, the treated Ag/Cu was washed two times with acetone (60.0 g) and dried overnight at room temperature.

The electrical performance of the treated Ag/Cu filler was evaluated in an epoxy resin composition containing 32 vol % filler and 68 vol % resin. In weight percent, the conductive composition contained 19 wt % epoxy resin (EPON 863), 1 wt % curing agent (2-ethyl-4-methyl imidazole) and 80 wt % coated Ag/Cu. The composition was cured at 170° C. for 30 minutes under nitrogen. The composition components and initial sheet resistivity are set out in the following table. The resistivity was tested as in the previous examples and compared to a control composition containing the same components, except that the Ag/Cu filler was not treated with PEDOT-PS S.

| Comparative Example | Comp Ex-4A | Comp Ex-4B | Control |
|---|---|---|---|
| Silver-plated copper (SPC) | 15.0 g | 15.0 g | 15.0 g |
| PEDOT-PSS (2.5 wt % solid) | 1.0 g | 0.20 g | |
| PEDOT to Ag/Cu weight ratio | 0.15% | 0.03% | |
| Acetone | 30.0 g | 30.0 g | |
| Initial SR in epoxy resin | 8.40 E−02 | 3.1 E−03 | 3.2 E−04 |
| composition (32 vol % filler) | | | |
| (ohm · cm) | | | |

The treated samples (4A and 4B) demonstrated higher initial resistivity (lower conductivity) compared with the untreated control sample after being formulated in an epoxy resin composition. The performance drop indicates formation of polymer coating on silver as well as on the copper. Even though the PEDOT is considered one of the best conductive polymers, it is less conductive than silver, and caused a loss in conductivity of the Ag/Cu particles. There was no selective coating solely of exposed copper in the Ag/Cu particles.

### Example 5

### Polymerization of Triethylene Glycol Dimethacrylate for Selective Coating to Exposed Copper on Ag/Cu Particles

In this example, coating selectivity to copper was demonstrated with a reactive methacrylate composition containing zinc ions. A control composition was prepared to contain both zinc ions and copper ions. Sample compositions were prepared to contain only zinc ions. Selective coating to copper was accomplished with the compositions containing only zinc ions. Since copper ion can accelerate the polymerization rate when coexisting with zinc ion, the coating forms only on exposed copper surfaces and not on silver surfaces due to the fact that copper ion is present only on the copper surface.

The control sample was prepared in a 20 mL vial, to which were added two grams of a solution of triethylene glycol dimethacrylate (TGM), Zn(BF4)2.xH2O, Cu(BF4)2.xH2O, benzyl peroxide, and sufficient acetone to fully dissolve all the components. The sample solutions were prepared the same, except that they did not contain Cu(BF4)2.xH2O and had varying amounts of benzyl peroxide.

A drop of each solution was placed onto each of a copper leadframe and a silver leadframe. After sixteen hours, the coated leadframes were washed by an excess of acetone to remove any un-reacted resin on surface. Then, visual and IR observations were used to evaluate whether the surface was free of any coating residues.

The compositions of the sample solutions in weight percent (wt %) and the results of the selectivity test are set out in the following table.

| Coating Composition | Ex-5A | Ex-5B | Ex-5C | Ex-5D | Ex-5E |
|---|---|---|---|---|---|
| TGM | 93 wt % | 97 wt % | 96.5 wt % | 96 wt % | 95 wt % |
| Zn(BF4)2•xH2O | 2 wt % | 0 wt % | 3 wt % | 3 wt % | 3 wt % |
| Cu(BF4)2•xH2O | 2 wt % | 0 wt % | 0.0 wt % | 0 wt % | 0 wt % |
| Benzyl Peroxide | 3 wt % | 3 wt % | 0.5 wt % | 1 wt % | 2 wt % |
| Coating residue | Yes | No | No | No | No |
| on silver substrate | | | | | |
| (after acetone wash) | | | | | |
| Coating residue on | Yes | No | Yes | Yes | Yes |
| copper substrate | | | | | |
| (after acetone wash) | | | | | |
| Selectivity to copper | No | No | Yes | Yes | Yes |

The data show that coating can be adjusted to occur solely on the exposed copper of Ag/Cu particles in the presence of Zn ion. Sample Ex-5A coated on both silver and copper surfaces due to the presence of the added copper ion. Sample Ex-5B containing neither Zn nor Cu ions did not coat on any substrate. Samples Ex-5C to Ex-5E containing only Zn ions coated only on the copper surface due to the presence of copper ions on the exposed copper surface. Samples Ex-5C to Ex-5E did not coat on the silver surface because there were no copper ions to accelerate the polymerization, even though Zn ions were present.

### Example 6

### Polymerization of Methacrylate for Selective Coating of Exposed Copper on Ag/Cu Particles

In this example, Ag/Cu powder was selectively coated with the reactive methacrylate system described in Example 5. Selectivity was triggered by the use of Zn and Cu ions that increase the polymerization rate in a typical methacrylate/benzyl peroxide system. Since copper ion can accelerate the polymerization rate when coexisting with zinc ion, the coating can be formed only on copper surface and not on silver, due to the fact that copper ion is present only on the exposed copper surface of the Ag/Cu particles and not on the silver surface.

In a 250 mL flask were added triethylene glycol dimethacrylate, Zn(BF₄)₂.xH₂O, benzyl peroxide and acetone in amounts shown in the table below. Each mixture was stirred for one hour at room temperature, allowed to settle overnight, and the supernatant then decanted. The treated Ag/Cu filler was washed three times with 60 g of acetone (60 g×3) before being dried overnight at room temperature.

The electrical performance of the treated Ag/Cu filler was evaluated in an epoxy resin composition containing 32 vol % filler and 68 vol % epoxy resin. In weight percent, the conductive epoxy resin composition contained 19 wt % epoxy resin (EPON 863), 1 wt % curing agent (2-ethyl-4-methyl imidazole) and 80 wt % coated Ag/Cu. The composition was cured at 170° C. for 30 minutes under nitrogen. The composition components, reaction conditions, and initial sheet resistivity are set out in the following table. The resistivity was tested as in the previous examples and compared to a control composition containing the same components, except that the Ag/Cu filler was not treated with triethylene glycol dimethacrylate and benzyl peroxide. SR is recorded in the values of ohm.cm.

| Coating Composition | EX-6A | | Ex-6B | | Ex-6C | | Control | |
|---|---|---|---|---|---|---|---|---|
| Ag/Cu | 15.0 | g | 15.0 | g | 15.0 | g | 15.0 | g |

| TGM | 1.0 | g | 0.50 | g | 0.25 | g |
|---|---|---|---|---|---|---|
| TGM to AgCu | 6.67% | | 3.33% | | 1.67% | |
| weight ratio | | | | | | |
| Zn(BF4)2•xH2O | 0.021 | g | 0.011 | g | 0.005 | g |
| Benzyl Peroxide | 0.005 | g | 0.005 | g | 0.002 | g |
| Acetone | 30.0 | g | 30.0 | g | 30.0 | g |

| | | | | |
|---|---|---|---|---|
| Initial SR in epoxy | 1.09E−03 | 3.39E−04 | 3.06E−04 | 3.17E−04 |
| resin composition | | | | |
| (32 vol % filler) | | | | |
| SR after aging at | 9.58E−04 | 3.31E−04 | 3.04E−04 | 3.35E−04 |
| 85° C./85% | | | | |
| RH for 168 hr | | | | |
| SR % increase | −12.2% | −2.5% | −0.7% | 5.6% |
| after aging at | | | | |
| 85° C./85% RH | | | | |
| for 168 hr | | | | |
| SR after aging at | 9.68E−04 | 3.76E−04 | 3.51E-04 | 4.62E−04 |
| 85° C./85% | | | | |
| RH for 336 hr | | | | |
| SR % increase after | −11.2% | 10.8% | 14.6% | 45.7% |
| aging at 85° C./85% | | | | |
| RH for 336 hr | | | | |
| SR after aging at | 9.86E−04 | 4.62E−04 | 4.15E-04 | 4.97E−04 |
| 85° C./85% | | | | |
| RH for 504 hr | | | | |
| SR % increase | −9.6% | 36.1% | 35.5% | 56.8% |
| after aging at | | | | |
| 85° C./85% RH | | | | |
| for 504 hr | | | | |

The results show treated Ag/Cu in the samples Ex-6B and Ex-6C demonstrated initial comparable sheet resistivity, and sample Ex-6A a slightly higher sheet resistivity, relative to the untreated Ag/Cu control, when formulated in epoxy resin compositions at the same filler loading (32 vol %). This indicates that the silver surface was not coated to any significant extent. After aging at 85° C. and 85% RH, sample Ex-6A, having the highest loading of polymer, showed a marked increase in conductivity with low resistivity values, and samples Ex-6B and Ex-6C showed lower resistivity than the control. The resistivity values of the samples with the treated Ag/Cu indicate that the exposed copper was selectively coated over the silver surface.

### Example 7

### Polymerization of Cycloaliphatic Acrylate for Selective Coating to Exposed Copper on Ag/Cu Particles

In this example, a cycloaliphatic diacrylate was used to selectively coat Ag/Cu powder using the procedure described in Example 6. The cycloaliphatic diacrylate system was chosen due to its ability to form a protective film with a higher Tg (glass transition temperature) and a lower oxygen permeation compared to the linear aliphatic dimethacrylate (TGM) of Example 6. Such properties are anticipated to give better oxidative protection on copper.

In a 250 mL flask were added Ag/Cu powder, tricyclodecane dimethanol diacrylate (SR833S from Sartomer), Zn(BF₄)₂.xH₂O, benzyl peroxide and acetone in amounts shown in the table below. The mixture was stirred for one hour at room temperature, allowed to settle overnight, and the supernatant then decanted. The treated Ag/Cu filler was washed three times with 60 g of acetone before drying overnight at room temperature.

The electrical performance of the treated Ag/Cu filler was evaluated in a conductive adhesive composition containing 32 vol % filler and 68 vol % resin. In weight percent, the conductive adhesive composition contained 19 wt % epoxy (EPON 863), 1 wt % curing agent (2-ethyl-4-methyl imidazole) and 80 wt % coated Ag/Cu. The composition was cured at 170° C. for 30 minutes under nitrogen gas. The composition components, reaction conditions, and sheet resistivities are set out in the following table. The resistivities were tested as in the previous examples and compared to a control composition containing the same components, except that the Ag/Cu filler was not treated with the acrylate system. SR is recorded in the values of ohm.cm.

| Coating Composition | Ex-7A | | Control | |
|---|---|---|---|---|
| Ag/Cu | 15.0 | g | 15.0 | g |

| SR833S | 0.8 | g |
|---|---|---|
| SR833s to AgCu weight ratio | 5.3% | |
| Zn(BF4)2.xH2O | 0.017 | g |
| Benzyl Peroxide | 0.004 | g |
| Acetone | 30.0 | g |

| | | |
|---|---|---|
| Initial SR in epoxy adhesive | 2.23E−04 | 3.17E−04 |
| (32 vol % filler) | | |
| SR after aging at 85° C./85% | 2.25E−04 | 3.35E−04 |
| RH for 168 hr | | |
| SR % increase after aging at | 0.8% | 5.6% |
| 85° C./85% RH for 168 hr | | |
| SR after aging at 85° C./85% | 2.82E−04 | 4.62E−04 |
| RH for 336 hr | | |
| SR % increase after aging at | 26.3% | 45.7% |
| 85° C./85% RH for 336 hr | | |
| SR after aging at 85° C./85% | 3.01E−04 | 4.97E−04 |
| RH for 504 hr | | |
| SR % increase after aging at | 35.0% | 56.8% |
| 85° C./85% RH for 504 hr | | |

The results show that treated Ag/Cu sample Ex-7A demonstrated initial comparable sheet resistivity, relative to the untreated Ag/Cu control when formulated in epoxy adhesives at the same filler loading (32 vol %). This indicates that the silver surface was not coated to any significant extent. After aging at 85° C. and 85% RI-I, the sample containing treated Ag/Cu (Ex-7A) showed consistently better conductivity (or lower resistivity) than the control sample throughout the aging period up to 504 hours. The resistivity values of the sample with the treated Ag/Cu indicate that the exposed copper was selectively coated over the silver surface.

### Example 8

### Polymerization of Aromatic Methacrylate for Selective Coating to Exposed Copper on Ag/Cu Particles

In this example, an aromatic dimethacrylate was polymerized to selectively coat Ag/Cu powder according to the procedure described in Examples 6 and 7. The aromatic dimethacrylate system is capable of forming a protective film with high Tg and lower permeability than the aliphatic acrylate, potentially giving good oxidative protection to copper. In a 250 mL flask were added Ag/Cu powder, ethoxylated (2) bisphenol A dimethacrylate (SR348, from Sartomer Inc.), Zn(BF₄)₂.xH₂O, benzyl peroxide and acetone in amounts shown in the table below. The mixture was stirred for one hour at room temperature, allowed to settle overnight, and the supernatant then decanted. The treated Ag/Cu filler was washed three times with 60 g of acetone before drying overnight at room temperature. The electrical performance of the treated Ag/Cu filler was evaluated in a conductive adhesive composition containing 32 vol % filler and 68 vol % resin. In weight percent, the conductive adhesive composition contained 19 wt % epoxy (EPON 863), 1 wt % curing agent (2-ethyl-4-methyl imidazole) and 80 wt % coated Ag/Cu. The composition was cured at 170° C. for 30 minutes under nitrogen. The composition components, reaction conditions, and sheet resistivities are set out in the following table. The resistivities were tested as in the previous examples and compared to a control composition containing the same components, except that the Ag/Cu filler was not treated with the acrylate system. SR is recorded in the values of ohm.cm.

| Coating Composition | Ex-8A | | Control | |
|---|---|---|---|---|
| Ag/Cu | 10.0 | g | 10.0 | g |

| SR348 acrylate | 0.25 | g |
|---|---|---|
| SR348 acrylate to AgCu weight ratio | 2.5% | |
| Zn(BF4)2•xH2O | 0.005 | g |
| Benzyl Peroxide | 0.005 | g |
| Acetone | 20.0 | g |

| | | |
|---|---|---|
| Initial SR in epoxy adhesive | 2.72E−04 | 3.17E−04 |
| (32 vol % filler) | | |
| SR after aging at 85° C./85% | 2.68E−04 | 3.35E−04 |
| RH for 168 hr | | |
| SR % increase after aging at | −1.4% | 5.6% |
| 85° C./85% RH for 168 hr | | |
| SR after aging at 85° C./85% | 3.19E−04 | 4.62E−04 |
| RH for 336 hr | | |
| SR % increase after aging at | 17.5% | 45.7% |
| 85° C./85% RH for 336 hr | | |

The results show that treated Ag/Cu samples Ex-8A demonstrated comparable initial sheet resistivity, relative to the untreated Ag/Cu control when formulated in epoxy adhesives at the same filler loading (32 vol %). This indicates that the silver surface was not coated to any significant extent. After aging at 85° C. and 85% RH, the sample containing treated Ag/Cu (Ex-8A) showed consistently better conductivity (or lower resistivity) than the control sample throughout the aging period up to 336 hours. The resistivity values of the sample with the treated Ag/Cu indicate that the exposed copper was selectively coated over the silver surface.

### Example 9

### Polymerization of Azide and Alkyne to Form a 1,2,3-Triazole for Selective Coating to Exposed Copper on Ag/Cu Particles (Click chemistry)

In this example, a 1,2,3-triazole was selectively coated to Ag/Cu powder through the polymerization of an azide and an alkyne, catalyzed by copper(I) ions. Copper (I) ions are formed in-situ only from the exposed copper surface, through a reaction between copper(II) ions and elemental copper.

In a 250 mL flask were added Ag/Cu powder, polyoxyethylene (PEO) bis(azide) (MW=2000 from Aldrich), propargyl ether (Aldrich), Cu(BF₄)₂.xH₂O, benzyl peroxide and acetone in amounts shown in the table below. The mixture was stirred for three hours at room temperature. After the supernatant was decanted, the treated Ag/Cu filler was washed three times with 60 g of acetone before being dried overnight at room temperature.

The electrical performance of the treated Ag/Cu filler was evaluated in a conductive adhesive composition containing 32 vol % filler and 68 vol % resin. In weight percent, the conductive adhesive composition contained 19 wt % epoxy (EPON 863), 1 wt % curing agent (2-ethyl-4-methyl imidazole) and 80 wt % coated Ag/Cu. The composition was cured at 170° C. for 30 minutes under nitrogen. The composition components, reaction conditions, and initial sheet resistivity and resistivities after aging are set out in the following table. The resistivities were tested as in the previous examples and compared to a control composition containing the same components, except that the Ag/Cu filler was not treated with the 1,2,3-triazole coating. SR is recorded in the values of ohm.cm.

| Coating Composition | Ex-9A | | Ex-9B | | Control |
|---|---|---|---|---|---|
| Ag/Cu | 15 | g | 15 | g | |
| Propargyl ether | 0.02 | g | 0.02 | g | |
| PEO_Bisazide | 0.1 | g | 0.05 | g | |
| Cu(BF4)2 | 0.025 | g | 0.025 | g | |

| | | | |
|---|---|---|---|
| acetone | 15 | 15 | |
| Initial SR in epoxy adhesive | 2.08E−04 | 4.84E−04 | 3.17E−04 |
| (32 vol % filler) | | | |
| SR after aging at 85° C./85% | 2.19E−04 | 4.90E−04 | 3.35E−04 |
| RH for 168 hr | | | |
| SR % increase after aging at | 5.4% | 1.1% | 5.6% |
| 85° C./85% | | | |
| RH for 168 hr | | | |
| SR after aging at 85° C./85% | 2.24E−04 | 5.47E−04 | 4.62E−04 |
| RH for 336 hr | | | |
| SR % increase after aging at | 7.6% | 13.0% | 45.7% |
| 85° C./85% | | | |
| RH for 336 hr | | | |
| SR after aging at 85° C./85% | 2.39E−04 | 5.77E−04 | 4.97E−04 |
| RH for 504 hr | | | |
| SR % increase after aging | 15.0% | 19.2% | 56.8% |
| at 85° C./85% | | | |
| RH for 504 hr | | | |

The results show that treated Ag/Cu samples Ex-9A and Ex-9B demonstrated initial comparable sheet resistivity, relative to the untreated Ag/Cu control when formulated in epoxy adhesives at the same filler loading (32 vol %). This indicates that the silver surface was not coated to any significant extent. After aging at 85° C. and 85% RH, both samples containing treated Ag/Cu (9A and 9B) show consistently less resistivity increase (more stable sheet conductivity) than the control throughout the aging period up to 504 hours. The resistivity values of the sample with the treated Ag/Cu indicate that the exposed copper was selectively coated over the silver surface, and that the reaction product of 1,2,3-triazole improves oxidative stability of Ag/Cu in conductive adhesive formulations.

### Example 10

### Polymerization of Epoxy Resin for Selective Coating of Exposed Silver on Ag/Cu Particles

The following example describes the process to selectively coat silver-plated copper with epoxy resin using silver and copper salts to generate cationic species by oxidation/reduction, which then trigger the epoxy polymerization. Three reaction solutions were prepared following the weight per cent ratios in the following table.

| Coating Composition | Ex-10A | Ex-10B | Ex-10C |
|---|---|---|---|
| Cycloaliphatic epoxy/ | 78.1 wt % | | |
| Daicel 2021 P | | | |
| Bis-A Epoxy/Epon 826 | | 34.5 wt % | |
| Bis-F Epoxy/Epon 863 | | | 71.2 wt % |
| Tri(ethylene glycol) | 19.52 wt % | 8.6 wt % | 26.8 wt % |
| divinyl ether | | | |
| Propylene carbonate | | 54.9 wt % | |
| AgSbF₆ | 2.4 wt % | 2.0 wt % | 2.0 wt % |

Into three separate 50 ml flasks were added 10 g of corresponding resin combinations from the table above, for Examples 10A, 10B, and 10C, and 3 g of silver-plated copper powder to prepare three different compositions. Each mixture was kept under vigorous stirring for five hours at room temperature using a magnetic stirrer. The silver-plated copper was filter and transferred to a 100 ml flask containing 50 ml of acetone and washed for 15 minutes. The particles were then filtered and vacuum dried at 60° C. for one hour.

The electrical performance of the treated Ag/Cu particles was evaluated in a conductive adhesive composition containing 32 vol % filler and 68 vol % resin. In weight percent, the conductive adhesive composition contained 19 wt % epoxy (Epiclon 835LV), 1 wt % curing agent (Omicure EM124) and 80 wt % of conductive filler. The composition was cured at 170° C. for 60 minutes under nitrogen. Resitivities were tested as in the previous examples and compared to a control composition containing the same components, except that the Ag/Cu filler in the control was not treated. SR is recorded in the values of ohm.cm.

| | | SR at | SR at | Increase in |
|---|---|---|---|---|
| Sample | SR initial | 168 hrs | 336 hrs | SR at 504 hrs |
| Control | 2.93E−04 | 3.32E−04 | 4.56E−04 | 55.4 % |
| Ex-10A | 1.55E−04 | 1.71E−04 | 1.95E−04 | 26.0 % |
| Ex-10B | 2.97E−04 | 3.08E−04 | 3.04E−04 | 2.6 % |
| Ex-10C | 2.64E−04 | 2.77E−04 | 2.92E−04 | 10.5 % |

The results show Ag/Cu, selectively treated with three different epoxy resins, present similar initial SR to the control, and improved aging stability compared to the control, indicating that the selective coating of the copper on the Ag/Cu filler was effective.

### Example 11

### Free Radical Polymerization for Selectively Coating Exposed Copper on Ag/Cu Particles

The electrical conductivity of a radically curable resin blend to selectively coat exposed copper on Ag/Cu particles is studied in this example.

| Adhesive Formulation | Master 11A | | Master 11 B | |
|---|---|---|---|---|
| Liquid bismaleimide resin ** | | | 13.35 | wt % |
| Epoxidized polybutadiene | | | 13.35 | wt % |
| (Epolead PB3600/Daicel) | | | | |
| Tricyclodecane dimethanol | 48.5 | wt % | 33.3 | wt % |
| diacrylate (Sartomer SR833S) | | | | |
| Isobornyl methacrylate | 48.5 | wt % | 36.7 | wt % |
| (Sartomer SR423A) | | | | |
| Dicumyl peroxide (Sigma-Aldrich) | 3.0 | wt % | 3.3 | wt % |

** cyclic isomers of dimer diester bismaleimide:

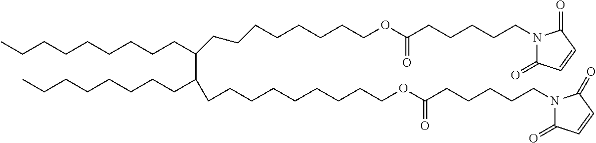 [SMILES: CCCCCCCCCC(CCCCCCCCOC(=O)CCCCCN1C(=O)C=CC1=O)C(CCCCCCCC)CCCCCCCCCOC(=O)CCCCCN1C(=O)C=CC1=O]

Two master resin formulations (Master 11A and Master 11B) were prepared following the weight per cent in the above table. All components were liquids and were mixed together at the same time for one minute at 3000rpm. Treated Ag/Cu filler was as prepared as in Example 1B.

The electrical performance of the treated Ag/Cu filler was evaluated in these two resin formulations containing 32 vol % filler and 68 vol % resin. In weight percent, the conductive formulations contained 20 wt % (for each of the Master 11A and Master 11B formulation) and 80 wt % of conductive filler. The compositions were cured at 170° C. for 60 minutes under nitrogen. The sheet resistivities were tested as in the previous examples and compared to a control composition containing the same components, except that the Ag/Cu filler was not treated. SR is recorded in the values of ohm.cm.

| | SR | SR at | SR at | SR at | SR at | SR at | Increase |
|---|---|---|---|---|---|---|---|
| Sample | initial | 168 hrs | 336 hrs | 504 hrs | 672 hrs | 840 hrs | in SR |
| 11A | 3.41E−04 | 3.34E−04 | 2.63E−04 | 2.99E−04 | 3.77E−04 | 4.11E−04 | 21% |
| Control | | | | | | | |
| 11A/ | 2.67E−04 | 2.57E−04 | 2.58E−04 | 2.80E−04 | 2.92E−04 | 2.99E−04 | 12% |
| Ex.1B | | | | | | | |
| 11B | 8.47E−04 | 1.34E−03 | 2.24E−02 | ** | ** | ** | 2550% |
| Control | | | | | | | |
| 11B/ | 9.24E−04 | 1.25E−03 | 2.57E−03 | ** | ** | ** | |
| Ex.1B | | | | | | | 178% |

**not measured

The data show that the initial SR values are at the same level of the control formulations. After aging at 85° C./85% RH, those formulations containing treated filler maintained a better electrical conductivity than their respective controls over time, indicating that the selective coating of exposed copper on Ag/Cu particles can be accomplished with in-situ polymerization of radically curable compositions.

1. Silver-plated copper particles in which any exposed copper not plated with silver is coated with a polymer or with a chelating compound capable of preventing oxidation of the exposed copper.

2. A method for preventing oxidation of any exposed copper on silver-plated copper particles comprising forming a polymer on, or coating a copper-chelating compound onto, the exposed copper on the silver-plated copper particles.

3. The method according to claim 2 in which a polymer is formed on the exposed copper on the silver-plated copper particles comprising coating monomers that will polymerize in the presence of copper or copper ions onto the silver-plated copper particles, and allowing the monomers to polymerize.

4. The method according to claim 3 in which the polymer is polyaniline.

5. The method according to claim 3 in which the polymer is an acrylate, a methacrylate, or a maleimide.

6. The method according to claim 3 in which the polymer is the 1,2,3-triazole reaction product of an azide and an alkyne.

7. The method according to claim 3 in which the polymer is a polymerized epoxy, oxetane, vinyl ether or a mixture of them.

8. The method according to claim 2 in which a chelating compound is coated onto the exposed copper on the silver-plated copper particles comprising coating a chelating compound having a stronger binding force to copper than to silver onto the silver-plated copper particles.

9. The method according to claim 8 in which the chelating compound is selected from the group consisting of oximes, azoles, amines, amides, amino acids, thiols, phosphates and xanthates.

10. A method for improving the conductivity stability of silver-plated copper particles comprising forming a polymer on, or coating a copper-chelating compound onto, the exposed copper on the silver-plated copper particles.

11. The method according to claim 10 in which a polymer is formed on the exposed copper on the silver-plated copper particles comprising coating monomers that will polymerize in the presence of copper or copper ions onto the silver-plated copper particles, and allowing the monomers to polymerize.

12. The method according to claim 11 in which the polymer is polyaniline.

13. The method according to claim 11 in which the polymer is an acrylate, a methacrylate, or a maleimide.

14. The method according to claim 11 in which the polymer is the 1,2,3-triazole reaction product of an azide and an alkyne.

15. The method according to claim 11 in which the polymer is a polymerized epoxy, oxetane, vinyl ether or mixture of them.

16. The method according to claim 10 in which a chelating compound is coated onto the exposed copper on the silver-plated copper particles comprising coating a chelating compound having a stronger binding force to copper than to silver onto the silver-plated copper particles.

17. The method according to claim 16 in which the chelating compound is selected from the group consisting of oximes, azoles, amines, amides, amino acids, thiols, phosphates and xanthates.
